(19) United States
(12) Patent Application Publication
(10) Pub. No.: US 2014/0079860 A1
(43) Pub. Date: Mar. 20, 2014

(54) Frozen Confection Device and Method

(71) Applicant: Chan King Ho, Tsing Yi New Territories (HK)

(72) Inventor: Chan King Ho, Tsing Yi New Territories (HK)

(21) Appl. No.: 13/622,635

(22) Filed: Sep. 19, 2012

(51) Int. Cl. A23G 9/26; A23G 3/02

(52) U.S. Cl. 426/515; 249/66.1

(57) ABSTRACT

Each of a plurality of silicone rubber molds is covered by a holder structure which has a flanged body, a handle extending from one side of the body, and an anchor structure extending from the other side of the body into the interior of the mold. The anchor structure has an enlarged outer end which engages with and tends to hold the frozen confection onto the handle for removal from the mold, and while the confection is being eaten.

This invention relates to devices and methods for making frozen confections, and particularly to such devices and methods for making frozen “pops.”

Numerous devices and methods have been proposed, sold and used in the past for making frozen confections. Typically, one or more molds is provided with a cap and a hole in the cap, through which a stick is inserted to be frozen into the confection as it is frozen.

Although such prior devices and methods have met with some success, they still suffer from troublesome problems.

One such problem is that several components are needed to make each frozen pop. This makes those devices relatively complex and cumbersome to use.

Another problem is that quite often the frozen confection slips loose from the stick to which it is frozen before the confection is eaten, with the result that the frozen confection must be handled in a relatively clumsy manner in order to be eaten.

Still other prior devices and methods are unduly complex and expensive to manufacture and sell.

Accordingly, it is an object of the invention to provide a device and method for making frozen confections which alleviates the foregoing problems.

In particular, it is an object of the invention to provide a device and method for making frozen confections which is relatively simple and easy to use.

It is a further object of the invention to provide such a device in which the frozen confection stays in place longer on the holder while the confection is being eaten.

It is a further object of the invention to provide such a device and method which is relatively easy to use, and is relatively simple and low in cost.

In accordance with the present invention, the foregoing objectives are met by the provision of one or more molds made out of flexible materials such as silicone rubber, and a cover structure for covering the opening of each of the molds, with a handle extending in one direction and an anchor structure extending in the other direction into the mold to be frozen into the confection.

Preferably, the cover structure includes a flanged body which is seated over the opening to the mold, a handle or stem extending outwardly from the flanged body to be easily grasped by the hand, and an anchor structure extending into the hollow cavity of the mold to firmly anchor the handle structure to the frozen confection as it is being withdrawn from the mold, and remain in place attached to the handle while the confection is being eaten.

Preferably, the anchor structure includes an elongated member with an enlarged end which is difficult to pull out of the frozen confection, thus anchoring the handle to the confection.

Preferably, the cover, handle and anchor structure comprise a single molded part which easily can be placed in covering relationship to the opening in the mold, and easily grasped to pull the frozen confection out of the mold, stretching the silicone rubber of the mold in order to release the confection from the mold.

The foregoing and other objects and advantages of the invention will be set forth in or apparent from the following description and drawings.

IN THE DRAWINGS:

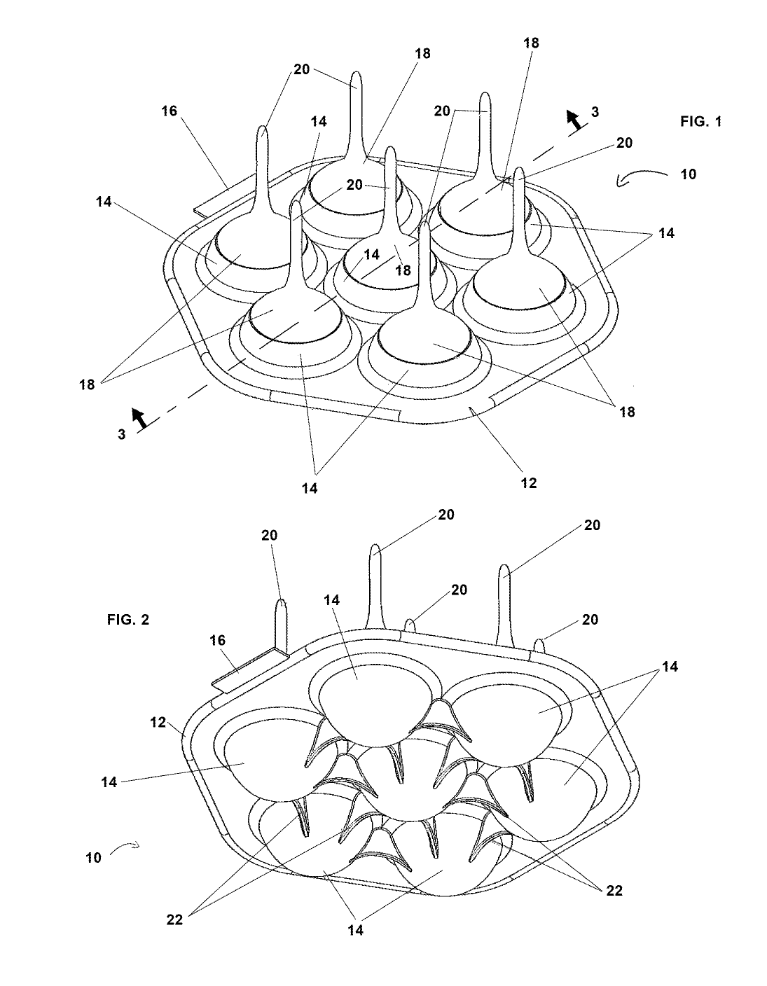

FIG. 1 is a top perspective view showing one embodiment of the invention;

FIG. 2 is a bottom perspective view of the device shown in FIG. 1;

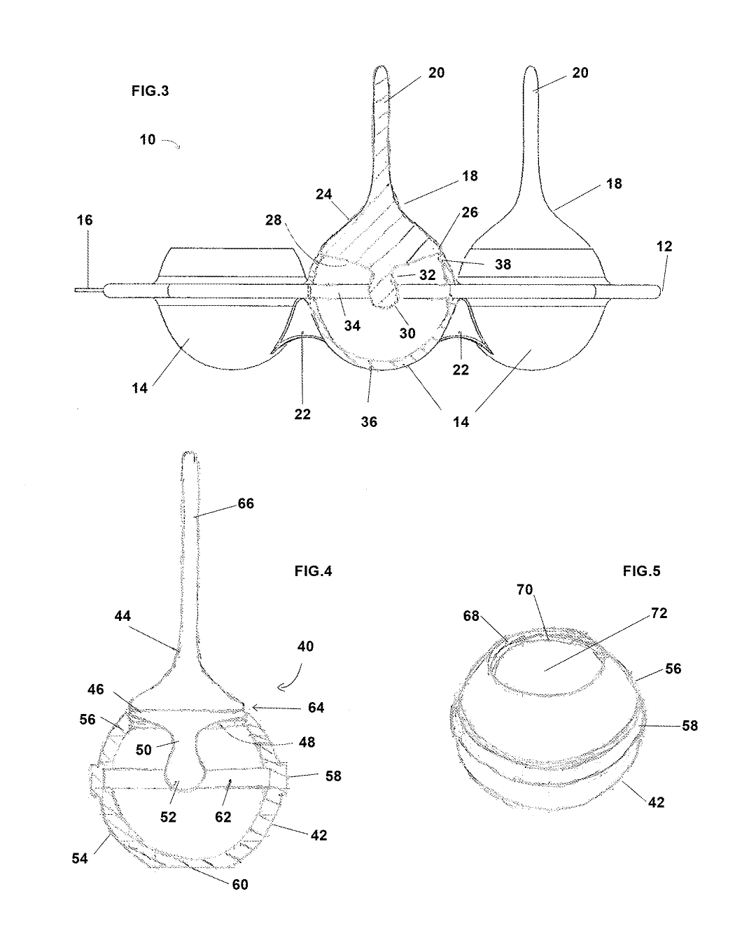

FIG. 3 is a partially schematic, partially cross-sectional front elevation view of a portion of the device shown in FIGS. 1 and 2. The cross-sectional view is taken along line 3-3 of FIG. 1;

FIG. 4 is a partially cross-sectional view similar to the central portion of FIG. 3, showing another embodiment of the invention; and

FIG. 5 is a perspective view of the mold portion of the embodiment shown in FIG. 4.

### FIRST EMBODIMENT

FIG. 1 is a top perspective view of a frozen confection molding device 10 including a molded plastic frame 12, and a plurality of silicone rubber molds 14 formed in the surface of the frame 12.

A holder structure 18 sits atop of each of the molds 14 and closes the inlet/outlet opening in the top of each mold.

As it can be seen in FIG. 2, the molds 14 are held in place and strengthened by a series of gussets 22. A tab 16 extends from the side of the frame 12 for ease in grasping the frame.

Each of the holders 18 has a vertically-extending stem or handle 20 which can be gripped with the hand to withdraw frozen confections from the molds and to hold the confections while eating them.

FIG. 3 shows a front elevation view of the molding device 10 with three of the molds 14 being shown. The center one of the three molds is shown in cross-section, as is the holder 18. The left one of the molds is shown without a holder 18.

As it can be seen in FIG. 3, the interior of the mold is hollow and is slightly more than a half-sphere. Therefore, the upper edges 38 of the mold are curved slightly inwardly. However, the material and wall thickness of the mold is such that the upper edges 38 of the mold are relatively flexible to allow easy release and removal of the frozen confection from the mold by pulling on the holder 18.

The material at the bottom 36 of the mold is somewhat thicker than the material at the upper edges 38.

The holder structure includes the upwardly-extending stem or handle 20, a tapered, gradually outwardly flaring lower portion 24, and a flanged body portion 26. At the outer edge of the flanged portion 26, the holder 18 body portion 26 rests against the upper lip of the mold and frictionally engages that lip to close the upper opening of the mold.

Below the flanged body portion 26, the contour of the holder 18 bends sharply inwardly at 28 to a central anchor structure consisting of a neck portion 32 extending downwardly, and an enlarged lower portion 30 which extends into the liquid in the mold when the mold is filled.

Preferably, the holder structure comprises a single unitary molded part having the contours shown in the drawings. Preferably, it is made of relatively hard plastic silicone material such as polystyrene.

In use, the device shown in FIGS. 1-3 is used by filling each of the empty molds with liquid to be frozen, applying one of the holder devices 18 to cover each of the molds, placing the frame and the other components in the freezer for a time until the liquid is frozen, and then simply grasping the handle end 20 and pulling upwardly to remove one of the frozen pops from each of the molds.

When the pops are eaten, because of the reentrant structure of the lower end or anchor portion of the holder 18, the anchor does not easily pull out of the frozen confection, so that the confection stays in place for a sufficient time to allow it to be eaten before it loosens.

Preferably, the size of the cavities of the molds 14 shown in FIGS. 1-3 for the first embodiment is relatively small.

### SECOND EMBODIMENT

A second embodiment of the invention is shown in FIGS. 4 and 5, in which the size of the frozen confection is preferably somewhat larger than in the first embodiment. Each frozen confection is made in a single, separate mold device 40, with a mold 42 shaped much like the molds 14 in FIGS. 1-3. However, the mold 42 is larger in size and has a somewhat thicker wall than the molds shown in FIGS. 1-3. Although each of the molds can be mounted in a frame like that shown in FIGS. 1-3, the device is shown as a separate mold to be frozen and removed from the freezer individually.

The holder structure 44 used in the FIG. 4 embodiment includes a vertical stem 66, a flanged body portion 46 with a groove 64 extending around the periphery of the flanged portion, a reentrant portion 48, a neck portion 50 and an enlarged end portion 52 forming the anchor structure.

Referring now to FIG. 5, the upper edge of the opening 72 of the mold 42 has two circular grooves 68, 70 which preferably mate with the groove 64 to help hold the holder structure 44 in position on the mold.

As it can be seen in FIGS. 3 and 4, each mold 14 and 42 has a horizontal, relatively wide groove 62 extending centrally around the inside wall of the mold. This forms a slight protrusion on the molded confection made in the mold and helps to provide a good release surface to facilitate release of the confection from the mold as it is being withdrawn.

The recess of the device 40 shown in FIG. 4 is at 62, and the recess of the device 10 shown in FIG. 3 is at 34. A ring of silicone rubber 58 extends on the outside of the mold body 42, as shown in FIGS. 4 and 5.

As it can be seen from the foregoing, the device of the invention amply meets the objective set forth above. The single molded holder structure 18 or 44 is easy to mold as a single part, and serves several different purposes. One purpose is to cover the inlet/outlet opening of the mold on which it sits, a second purpose is to anchor the holder into the frozen confection and hold it there, and a third purpose is to provide a convenient handle 20 or 66 to grasp and withdraw the confection from the mold, and to hold the confection while it is being eaten.

Therefore, the molding device uses relatively few parts, and thus is relatively simple and easy to use, as well as to manufacture. Moreover, the device increases the enjoyment of the user in that confection stays on the holder longer than in most past devices.

The above description of the invention is intended to be illustrative and not limiting. Various changes or modifications in the embodiments described may occur to those skilled in the art. These can be made without departing from the spirit or scope of the invention.

1. A frozen confection mold device comprising
a. a mold body made of flexible material for releasing a frozen confection from said mold, said mold body having a flexible side wall forming a hollow interior with a restricted inlet/outlet opening, said opening having a width smaller than the width of said hollow interior,
b. a cover for said inlet/outlet opening, said cover having a flanged member with two opposed sides and which is dimensioned and shaped to match said opening and to fit on said mold and cover said opening,
c. a stem forming a hand-hold member extending from one of said sides of said flanged member,
d. a holding projection extending from the opposite side of said flanged member to extend into the interior of said mold when said cover is in place covering said opening,
e. said bolding projection having an enlarged portion spaced from said flanged member to assist in securing said frozen confection to said stem when said frozen confection is removed from said mold,
f. in which said mold body has a recess around said inlet/outlet opening, said cover having an outer edge shaped and sized to fit into and rest in said recess.

2. (canceled)

3. A device as in claim 1 in which said cover, said stem and said holding projection comprise a single integral molded part.

4. A device as in claim 1 including an integral frame and a plurality of said mold bodies mounted in said frame, and one of said cover, said stem and said holding projection for each of said molds.

5. A device as in claim 1 including an integral frame, a plurality of receiving cavities, each for receiving one of a plurality of said mold bodies and releasably holding said mold body in said frame.

6. A device as in claim 1 in which said side wall of said mold body has a semi-spherical internal surface so as to produce a semi-spherical frozen confection.

7. (canceled)

8. (canceled)

9. (canceled)

10. (canceled)

11. (canceled)

12. (canceled)
